(19) United States
(12) Patent Application Publication
(10) Pub. No.: US 2017/0220322 A1
(43) Pub. Date: Aug. 3, 2017

(54) GENERATING GAUSSIAN RANDOM NUMBERS USING INVERSE SAMPLING AND RECURRENCE RELATIONSHIP

(71) Applicant: International Business Machines Corporation, Armonk, NY (US)

(72) Inventor: Niranjan Vaish, Bangalore (IN)

(21) Appl. No.: 15/008,531

(22) Filed: Jan. 28, 2016

(51) Int. Cl. G06F 7/58

(52) U.S. Cl. CPC G06F 7/588

(57) ABSTRACT

A computer-implemented method includes determining a qualified uniform random number. The method further includes determining an approximation recurrence relationship. The method further includes assigning a predefined starting value to a primary index variable. The method further includes repeating the steps of determining a cumulative probability value associated with the primary index variable and incrementing the value of the primary index variable, until the cumulative probability value is greater than or equal to the qualified uniform random number. The method further includes, responsive to the cumulative probability value being greater than or equal to the qualified uniform random number, assigning the value of the primary index variable to an output random number. A corresponding computer system and computer program product are also disclosed herein.

### BACKGROUND OF THE INVENTION

The present invention relates generally to random number generation, and more particularly to random number generation based on the Gaussian probability distribution.

Generating random numbers is important in computer software systems dedicated to security and simulation applications. When the underlying distribution of a computer model is based on a particular probability distribution, the random number generation method is more effective in achieving its goal of randomization if it takes into account the underlying properties of that distribution. One such probability distribution is the Gaussian probability distribution, which is a continuous probability distribution that conforms to the central limit theorem.

### SUMMARY

Embodiments of the present invention disclose a method, computer program product, and computer system for Gaussian random number generation. In one embodiment, in accordance with the present invention, the computer-implemented method includes determining a qualified uniform random number. The method further includes determining an approximation recurrence relationship. The method further includes assigning a predefined starting value to a primary index variable. The method further includes repeating the steps of determining a cumulative probability value associated with the primary index variable and incrementing the value of the primary index variable, until the cumulative probability value is greater than or equal to the qualified uniform random number. The method further includes, responsive to the cumulative probability value being greater than or equal to the qualified uniform random number, assigning the value of the primary index variable to an output random number. A corresponding computer system and computer program product are also disclosed herein.

### BRIEF DESCRIPTION OF THE DRAWINGS

FIG. 1 is a functional block diagram illustrating a distributed data processing environment, in accordance with an embodiment of the present invention;

FIG. 2 is a data-flow diagram of a program for Gaussian random number generation executed within the distributed data processing environment of FIG. 1, in accordance with an embodiment of the present invention;

FIG. 3 is a flowchart depicting operational steps of a program for Gaussian random number generation executed within the distributed data processing environment of FIG. 1, in accordance with an embodiment of the present invention; and

FIG. 4 depicts a block diagram of components of a computing device of FIG. 1, in accordance with an embodiment of the present invention.

### DETAILED DESCRIPTION

Generating random numbers based on Gaussian probability distribution is important to unpredictable access or retrieval of information in Gaussian computer models. Existing methods of Gaussian random number generation are costly either computationally and/or memory-wise. For instance, the Box-Muller Transform method involves costly trigonometric calculations, while the so-called Ziggurat method uses inefficient reject sampling and relies highly on extensive pre-compute tables. Developers and users of Gaussian computer models continue to face challenges with a lack of efficiency in Gaussian random number generators.

Embodiments of the present invention recognize that it may be desirable to generate random numbers according to a Gaussian probability distribution through employing an inverse sampling random number generation method. Embodiments of the present invention recognize that, by approximating the probability density function associated with a Gaussian probability distribution with a recurrence relationship, a cumulative probability value for a random variable can be calculated using the inverse sampling method. Embodiments of the present invention recognize that employing recurrence random sampling can lead to less computationally intensive or memory intensive methods of generating random numbers according to a Gaussian probability distribution.

Implementation of embodiments of the invention may take a variety of forms, and exemplary implementation details are discussed subsequently with reference to the Figures.

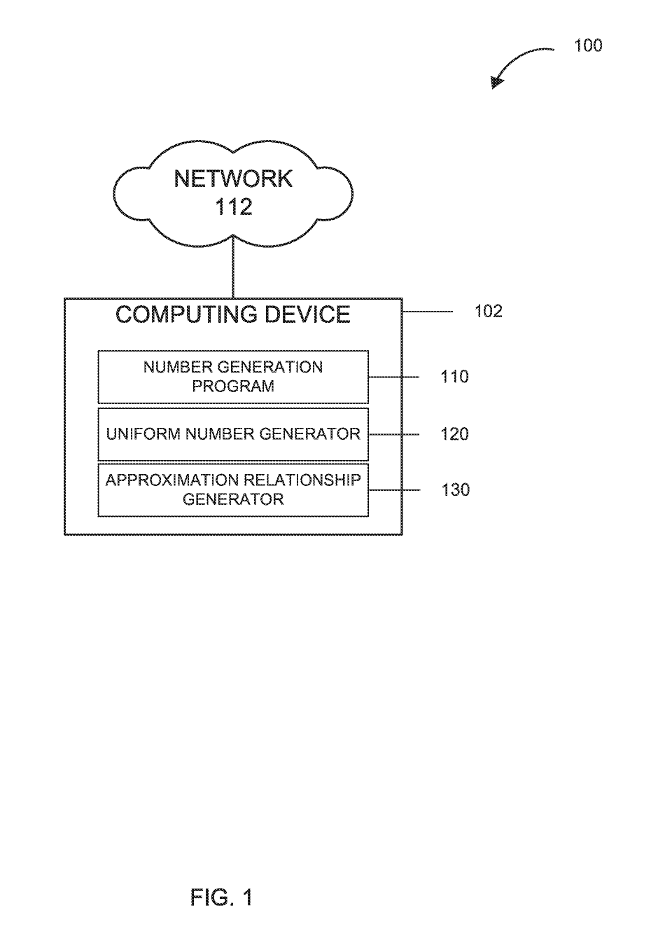

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 102 connected to network 112. Network 112 represents, for example, a telecommunications network, a local area network (LAN), a wide area network (WAN), such as the Internet, or a combination of the three, and includes various connection types, such as wired, wireless, and/or fiber optic connections. Network 112 includes one or more wired and/or wireless networks that are capable of receiving and transmitting data, voice, and/or video signals, including multimedia signals that include voice, data, and video information.

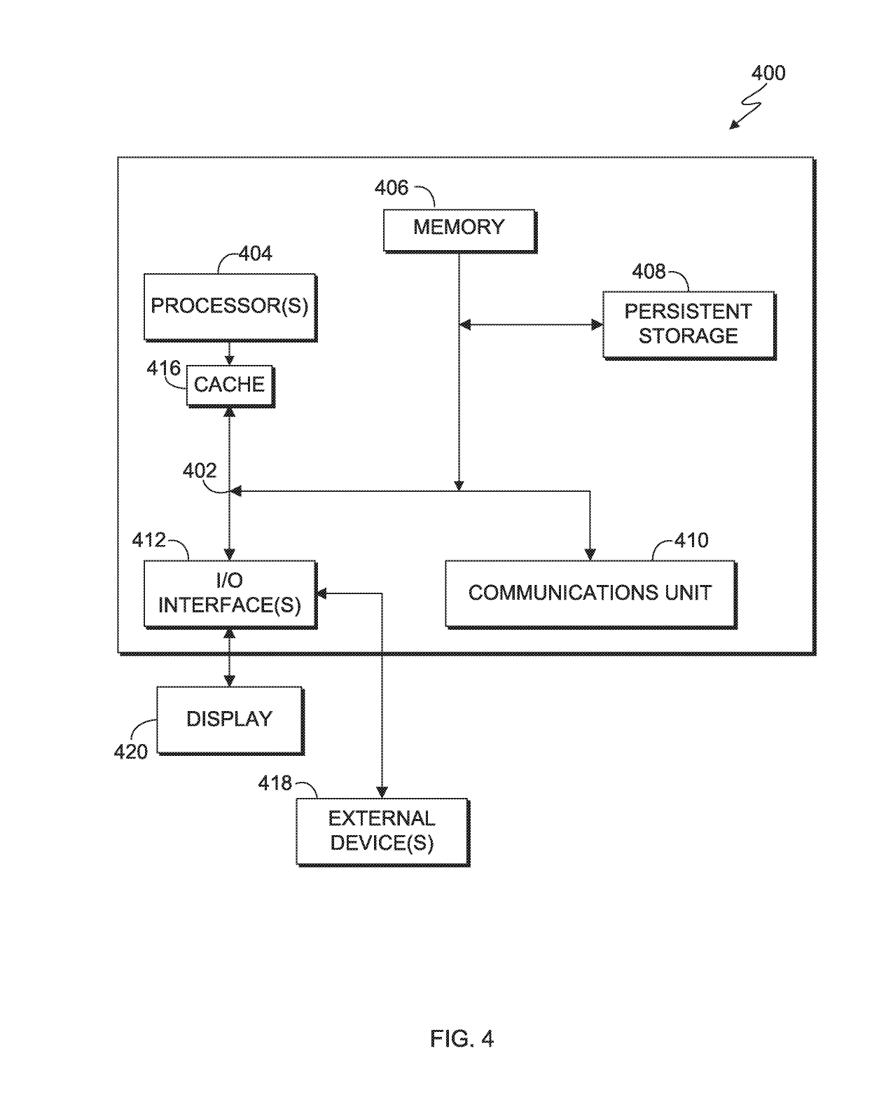

In the depicted environment, computing device 102 is one or more of a management server, a web server, or any other electronic device or computing system capable of receiving, analyzing, and sending data. In some embodiments, computing device 102 represents a server computing system utilizing multiple computers as a server system, such as in a cloud computing environment. In another embodiment, computing device 102 represents a laptop computer, a tablet computer, a netbook computer, a personal computer (PC), a desktop computer, a personal digital assistant (PDA), a smart phone, or any programmable electronic device capable of communicating with network 112. In another embodiment, computing device 102 represents a computing system utilizing clustered computers and components to act as a single pool of seamless resources. Computing device 102 may include components as depicted and described in further detail with respect to FIG. 4, in accordance with embodiments of the present invention. Computing device 102 includes number generation program 110, uniform number generator 120, and approximation relationship generator 130.

In depicted distributed data processing environment 100, number generation program 110 resides on computing device 102 and receives a qualified uniform random number, as defined below, from uniform number generator 120. In at least some embodiments, uniform random number generator 120 is any combination of one or more computer (hardware and/or software) components capable of generating a qualified uniform random number, as defined below. In the distributed data processing environment 100, number generation program 110 also receives an approximation recurrence relationship from an approximation relationship generator 130. In at least some embodiments, approximation relationship generator 130 is any combination of one or more computer (hardware and/or software) components capable of generating an approximation recurrence relationship, as defined below, to be generated. In various embodiments, number generation program 110 receives at least one of a qualified uniform random number or an approximation recurrence relationship from a computing device (not depicted) including at least one of uniform number generator or approximation relationship generation via network 112. In some embodiments, number generation program 110 receives at least one of a qualified uniform random number or an approximation recurrence relationship directly (e.g., via a removable disk) and not via network 112.

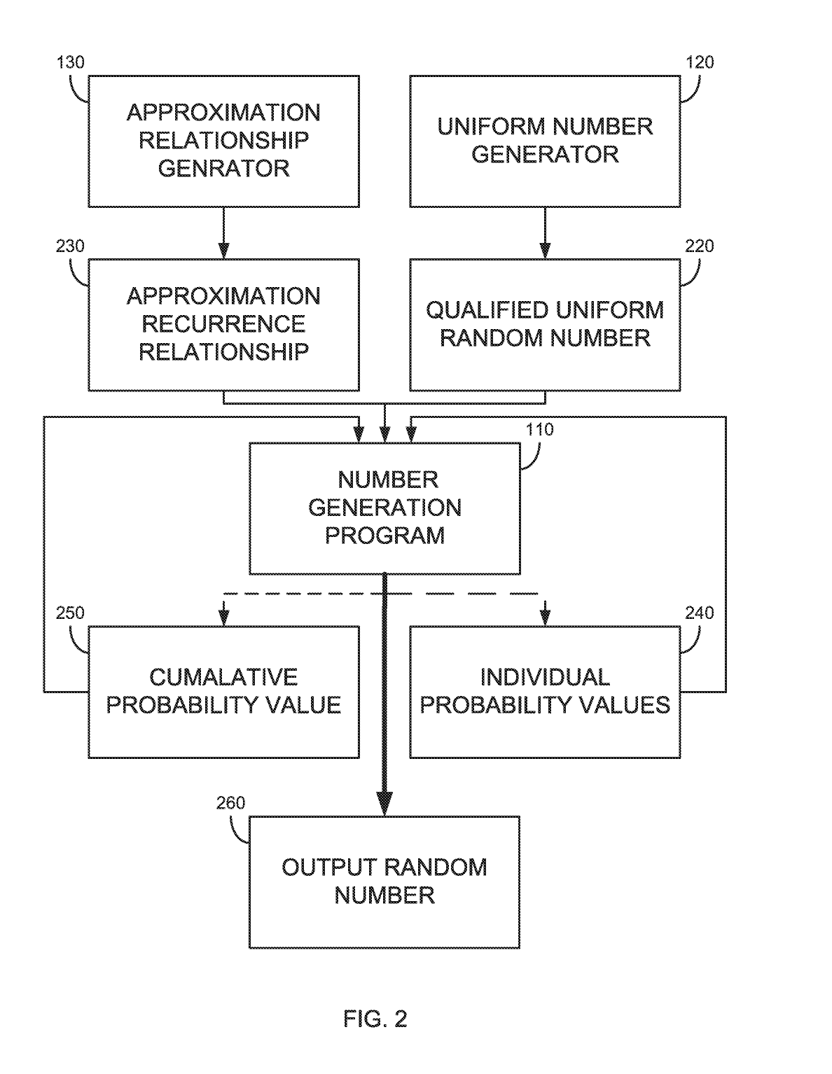

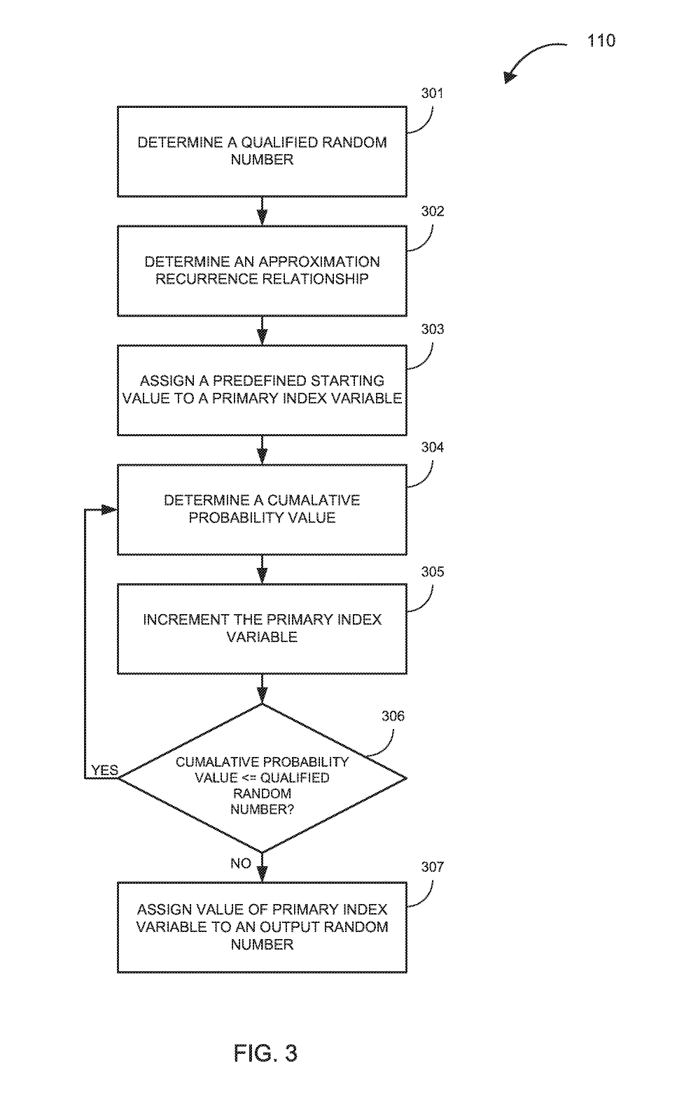

In at least some embodiments, random number generation program 110 uses the approximation recurrence relationship and the qualified uniform random number to generate an output random number, as defined below, in accordance with the procedure described with respect to FIGS. 2 and 3. In some embodiments, the output random number may be stored in a database, supplied to at least one user, or supplied to at least one other computer (hardware or software) component.

FIG. 2 is a data-flow diagram of a program for Gaussian random number generation executed within the distributed data processing environment of FIG. 1, in accordance with an embodiment of the present invention. In the embodiment depicted in FIG. 2, uniform number generator 120 generates a qualified uniform random number 220 and approximation relationship generator 130 generates an approximation recurrence relationship 230. In at least some embodiments, a qualified uniform random number is a random number defined to be within a predefined range (e.g., between 0 and 1). In at least some embodiments, an approximation recurrence relationship is a Poisson-approximation recurrence relationship that approximates the probability density function associated with a Gaussian probability distribution, such as the following recursive approximation relationship:

IP[i]=QCN/QCN+i·lP[i−1] Equation 1

IP[0]=1/\sqrt{2π·QCN} Equation 2

In the recursive approximation relationship noted above, the value of IP[i] (i.e., denoting individual probability of i) is an approximation of the value of the probability density function for a Gaussian distribution with an input of “i.” QCN (i.e. denoting qualified constant number) is an example of a qualified constant number introduced below and is a predefined constant value (e.g., 10,000). In at least some embodiments, QCN is a value greater than 1,000. In the embodiments using Equations 1 and 2 noted above, the number generation program 110 calculates individual probability value associated with a random variable value by: (1) dividing QCN by QCN+1; and (2) multiplying the resultant value by the recursively calculated value of IP[i−1]. In at least some of those embodiments, the program 110 calculates the value of IP[0] by calculating the inverse of the square root of 2π multiplied by QCN.

In at least some embodiments, a Poisson-approximation recurrence relationship is a recurrence relationship that approximates the value of the individual probability value (i.e., the probability density function value) and/or the cumulative probability value (i.e. the cumulative probability density function value) associated with a random variable value in a particular probability distribution (e.g., the Gaussian probability distribution) using the properties of a Poisson probability distribution. The inventor has recognized that the Poisson probability distribution can be used to approximate the properties of a Gaussian probability distribution, a result not recognized before in the art.

In the embodiment depicted in FIG. 2, the number generation program 110 uses the qualified uniform random number 220 and the approximation recurrence relationship 230 to generate one or more individual probability values 240 (i.e., one or more approximations of the value of the probability density function associated with a Gaussian distribution given one or more inputs of random variables). The number generation program 110 uses the one or more individual probability values 240 to determine one or more cumulative probability values 250 (i.e., one or more approximations of the value of the cumulative density functions associated with a Gaussian distribution given one or more inputs of random variables). The number generation program uses the one or more cumulative probability values 250 to determine an output random number 260 (i.e., a random number according to a Gaussian probability distribution).

In the example of recursive approximation relationship noted above, an individual probability value 240 associated with a particular random variable is determined in a recursive manner relying on the individual probability values 240 associated with all non-negative integer random variables less than the particular random variable and a base equation for calculating the individual probability value 240 associated with the random variable zero. The cumulative probability value 250 associated with a particular random variable is determined by adding the individual probability value 240 associated with the particular random variable with the individual probability values 240 associated with all non-negative integer random variables less than the particular random variable. In at least some embodiments, the output random number 260 is the smallest random variable whose associated cumulative probability value 250 is equal to or exceeds the qualified uniform random number 220.

FIG. 3 is a flow-chart diagram of a program for Gaussian random number generation executed within the distributed data processing environment of FIG. 1, in accordance with an embodiment of the present invention. In at least some embodiments, number generation program 110 begins by at least one of one or more user requests or one or more requests from one or more computer (hardware or software) components. In some embodiments, the program may receive at least one of the qualified random number 220 and the approximation recurrence relationship 230 from at least one computer (hardware or software) component.

In the embodiment depicted in FIG. 3, the number generation program 110 determines, by one or more computer processors, a qualified uniform random number at step 301. In some embodiments, determining a qualified uniform random number comprises receiving the qualified uniform random number from one or more computer (hardware and/or software) components and/or from one or more user inputs. In other embodiments, determining a qualified uniform random number comprises generating and/or receiving an ordinary random number (i.e., a random number not defined to be within a predefined range, unlike the qualified uniform random number) and converting the ordinary random number to a qualified uniform random number through at least one random number conversion subroutine (e.g., a random number conversion subroutine comprising instructions for dividing the ordinary random number by a predefined upper-bound for such ordinary random numbers, to produce qualified uniform random numbers defined to be within the range of 0 and 1).

In the embodiment depicted in FIG. 3, the number generation program 110 determines, by the one or more computer processors, an approximation recurrence relationship at step 302. In some embodiments, determining an approximation recurrence relationship comprises receiving the approximation recurrence relationship from one or more computer (hardware and/or software) components and/or one or more user inputs. In other embodiments, determining an approximation recurrence relationship comprises generating and/or receiving one or more building block components of the approximation recurrence relationship (i.e., one or more qualified constant numbers used to determine the approximation recurrence relationship) and determining the approximation recurrence relationship based on the one or more building block components of the approximation recurrence relationship.

In some embodiments, determining the approximation recurrence relationship comprises determining, by the one or more computer processors, a qualified constant number, and determining, by the one or more computer processors, a Poisson approximation recurrence relationship based on the qualified constant number. In at least some embodiments, a qualified constant number is a constant number defined to be within a predefined range (e.g., a constant number more than 1,000). In some embodiments, a Poisson approximation recurrence relationship, such as the Poisson approximation relationship introduced with respect to FIG. 2 above, is any recurrence relationship produced using properties of a Poisson probability distribution that approximates at least one feature and/or quality of a Gaussian probability distribution.

In the embodiment depicted in FIG. 3, the number generation program 110 assigns, by the one or more computer processors, a predefined starting value to a primary index variable at step 303. The program 110 determines, by the one or more computer processors, a cumulative probability value associated with the primary index variable at step 304. In some embodiments, to determining the cumulative probability value, the program identifies a global probability sum associated with the primary index variable. The program then, for each secondary index variable in the range from the predefined starting value to the primary index value determines an individual probability value associated with the secondary index value based on the approximation recurrence relationship; and adjusts the global probability sum based on the individual probability value. In some embodiments, adjusting the global probability sum is performed, by the one or more computer processors, according to a trapezoidal summation relationship between the individual probability values corresponding to each secondary value. In at least some embodiments, a trapezoidal summation relationship is a relationship that approximates the result of a summation by calculating the area of one or more trapezoids that each align with the result of at least one step and/or part the summation.

In some embodiments, identifying a global probability sum comprises determining a starting value (e.g., zero) for the global probability sum. In some embodiments, the starting value associated with the global probability sum is determined based on one or more properties (e.g., mean, median, standard deviation, and the like) of the particular Gaussian probability distribution based on which random numbers are generated. In some embodiments, the starting value associated with the global probability sum is adjusted based on one or more properties associated with the computer system in which the number generation program 110 is implemented (e.g., the speed and/or storage capability of the computer system).

In some embodiments, determining an individual probability value associated with the secondary index value comprises determining the individual probability value using an approximation recurrence relationship. In some embodiments, the individual probability value associated with the secondary index value is adjusted based on one or more properties (e.g., mean median, standard deviation, and the like) of the particular Gaussian probability distribution based on which random numbers are generated. In some embodiments, the individual probability value associated with the secondary index value is adjusted based on one or more properties associated with the computer system in which the number generation program 110 is implemented (e.g., the speed and/or storage capability of the computer system).

In some embodiments, adjusting the global probability sum based on the individual probability value comprises adding the individual probability value to the global probability sum. In some embodiments, the final value of the global probability sum is adjusted based on one or more properties (e.g., median, mean, standard deviation, and the like) of the particular Gaussian probability distribution based on which random numbers are generated In some embodiments, the final value of the global probability sum is adjusted based on one or more properties associated with the computer system in which the number generation program 110 is implemented (e.g., the speed and/or storage capability of the computer system).

In the embodiment depicted in FIG. 3, the number generation program 110 increments, by the one or more computer processors, the value of the primary index variable at step 305. In some embodiments, step 305 is performed in response to input from at least one computer (hardware or software) component. In some embodiments, incrementing, by the one or more processors, the value of the primary index variable comprises removing the previous value of the primary index variable stored in memory and storing the new value in the same set of memory locations as the one in which the previous value of the primary index variable was stored. In some embodiments, incrementing, by the one or more processors, the value of the primary index variable comprises removing the previous value of the primary index variable stored in memory and storing the new value in a different set of memory locations from the one in which the previous value of the primary index variable was stored.

In the embodiment depicted in FIG. 3, the number generation program 110 determines, by the one or more computer processors, whether the cumulative probability value is greater than or equal to the qualified uniform random number at step 306. In some embodiments, step 306 is performed in response to input from at least one computer (hardware or software) component. In some embodiments, determining, by the one or more computer processors, whether the cumulative probability value is greater than or equal to the qualified uniform random number comprises subtracting the qualified uniform random number from the cumulative probability value and determining if the result of the subtraction is a zero or positive value. In some embodiments, determining, by the one or more computer processors, whether the cumulative probability value is greater than or equal to the qualified uniform random number comprises subtracting the cumulative probability value from the qualified uniform random number and determining if the result of the subtraction is a negative value.

In the embodiment depicted in FIG. 3, the number generation program 110 repeats steps 304, 305, and 306 until the cumulative probability value is greater than or equal to the qualified uniform random number. In some embodiments, the repetition is performed in response to input from at least one computer (hardware or software) component. In some embodiments, the repetition is accomplished using a loop programming structure. In some embodiments, the repetition is accomplished using a recursive programming structure.

In the embodiment depicted in FIG. 3, responsive to the cumulative probability value being greater than or equal to the qualified uniform random number, the number generation program 110 assigns the value of the primary index variable to an output random number at step 307. In some embodiments, step 307 is performed in response to receiving an input from at least one computer (hardware or software) component. In some embodiments, the program 110 adjusts the output random number based on one or more properties (e.g., median, mean, standard deviation, and the like) of the particular Gaussian probability distribution based on which random numbers are generated. In some embodiments, the program 110 adjusts the output random number based on one or more properties associated with the computer system in which the number generation program 110 is implemented (e.g., the speed and/or storage capability of the computer system).

In some embodiments, the qualified uniform random number is a number greater than one half and less than one; and the predefined starting value is zero. In at least some of those embodiments, the number generation program 110 generates an output random number based on the properties and/or distribution of a normalized Gaussian probability distribution. In some embodiments, at least one of the approximation recurrence relationship or each cumulative probability value is determined, by the one or more computer processors, based on one or more properties associated with at least one normal information transmission channel (i.e., an information transmission channeled whose values can be modeled in whole or in part based on Gaussian probability distribution and/or normal probability distribution). In some embodiments, the number generation program 110 determines, by the one or more computer processors, a sign indicator associated with the qualified uniform random number, and adjusts, by the one or more computer processors, the output random number based on the sign indicator. In at least some embodiments, a sign indicator associated with a number is any indication of the sign (i.e., positive or negative) associated with the number. In at least some embodiments, adjusting the output number based on the sign indicator comprises transforming (i.e., multiplying and/or dividing) positive output numbers by a positive number and transforming negative output numbers by a negative number.

Aspects of the present invention enable Gaussian random number generation without the need for costly trigonometric calculation or storage-intensive pre-computed tables that also impose computational bottlenecks on the program. Aspects of the present invention enable inverse sampling for random number generation based on Gaussian probability distribution by approximating the cumulative density function for Gaussian probability distribution. Nevertheless, the aforementioned advantages are not required to be present in all of the embodiments of the invention and may not be present in all of the embodiments of the invention.

FIG. 4 depicts a block diagram of components of computer 400, which is representative of computing device 102, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications, and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media. Software and data 422 are stored in persistent storage 408 for access and/or execution by processor(s) 404 via one or more memories of memory 406.

In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Software and data 422 may be downloaded to persistent storage 408 through communications unit 410.

I/O interface(s) 412 allows for input and output of data with other devices that may be connected to computer 400. For example, I/O interface(s) 412 may provide a connection to external device(s) 418 such as a keyboard, a keypad, a touch screen, and/or some other suitable input device. External device(s) 418 can also include portable computer readable storage media such as, for example, thumb drives, portable optical or magnetic disks, and memory cards. Software and data 422 can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for Gaussian random number generation, the method comprising:
determining, by one or more computer processors, a qualified uniform random number;
determining, by the one or more computer processors, an approximation recurrence relationship;
assigning, by the one or more computer processors, a predefined starting value to a primary index variable;
repeat:
determining, by the one or more computer processors, a cumulative probability value, the cumulative probability value being associated with the primary index variable; and
incrementing, by the one or more computer processors, the value of the primary index variable;
until the cumulative probability value is greater than or equal to the qualified uniform random number; and
responsive to the cumulative probability value being greater than or equal to the qualified uniform random number, assigning, by the one or more computer processors, the value of the primary index variable to an output random number.

2. The method of claim 1, wherein:
the qualified uniform random number is a number greater than one half and less than one; and
the predefined starting value is zero.

3. The method of claim 1, further comprising:
determining, by the one or more computer processors, a sign indicator, the sign indicator being associated with the qualified uniform random number; and
adjusting, by the one or more computer processors, the output random number based on the sign indicator.

4. The method of claim 1, wherein at least one of the approximation recurrence relationship or each cumulative probability value is determined, by the one or more computer processors, based on one or more properties associated with at least one normal information transmission channel.

5. The method of claim 1, wherein determining the approximation recurrence relationship comprises:
determining, by the one or more computer processors, a qualified constant number; and
determining, by the one or more computer processors, a poisson approximation recurrence relationship based on the qualified constant number.

6. The method of claim 1, wherein determining the cumulative probability value comprises:
identifying, by the one or more computer processors, a global probability sum, the global probability sum being associated with the primary index variable;
for each secondary index variable in the range from the predefined starting value to the primary index value:
determining, by the one or more computer processors, an individual probability value based on the approximation recurrence relationship, the individual probability value being associated with the secondary index value; and
adjusting, by the one or more computer processors, the global probability sum based on the individual probability value.

7. The computer-implemented method of claim 6, wherein adjusting the global probability sum is performed, by the one or more computer processors, according to a trapezoidal summation relationship between the individual probability values corresponding to each secondary value.

8. A computer program product for authentication, the computer program product comprising:
one or more computer readable storage media and program instructions stored on the one or more computer readable storage media, the program instructions comprising:
program instructions to determine, by one or more computer processors, a qualified uniform random number;
program instructions to determine, by the one or more computer processors, an approximation recurrence relationship;
program instructions to assign, by the one or more computer processors, a predefined starting value to a primary index variable;
program instructions to repeat:
determining, by the one or more computer processors, a cumulative probability value, the cumulative probability value being associated with the primary index variable; and
incrementing, by the one or more computer processors, the value of the primary index variable by one;
until the cumulative probability value is greater than or equal to the qualified uniform random number; and
responsive to the cumulative probability value being greater than or equal to the qualified uniform random number, program instructions to assign, by the one or more computer processors, the value of the primary index variable to an output random number.

9. The computer program product of claim 8, wherein:
the qualified uniform random number is a number greater than one half and less than one; and
the predefined starting value is zero.

10. The computer program product of claim 8, further comprising program instructions to:
determine, by the one or more computer processors, a sign indicator, the sign indicator being associated with the qualified uniform random number; and
adjust, by the one or more computer processors, the output random number based on the sign indicator.

11. The computer program product of claim 8, wherein at least one of the approximation recurrence relationship or each cumulative probability value is determined, by the one or more computer processors, based on one or more properties associated with at least one normal information transmission channel.

12. The computer program product of claim 8, wherein program instructions to determine the approximation recurrence relationship further comprise instructions to:
determine, by the one or more computer processors, a qualified constant number; and
determine, by the one or more computer processors, a poisson approximation recurrence relationship based on the qualified constant number.

13. The computer program product of claim 8, wherein program instructions to determine the cumulative probability value further comprise program instructions to:
identify, by the one or more computer processors, a global probability sum, the global probability sum being associated with the primary index variable;
for each secondary index variable in the range from the predefined starting value to the primary index value:
determine, by the one or more computer processors, an individual probability value based on the approximation recurrence relationship, the individual probability value being associated with the secondary index value; and
adjust, by the one or more computer processors, the global probability sum based on the individual probability value.

14. The computer program product of claim 13, wherein adjusting the global probability sum is performed, by the one or more computer processors, according to a trapezoidal summation relationship between the individual probability values corresponding to each secondary value.

15. A computer system for authentication, the computer system comprising:
one or more computer processors;
one or more computer readable storage media;
program instructions to determine, by the one or more computer processors, a qualified uniform random number;
program instructions to determine, by the one or more computer processors, an approximation recurrence relationship;
program instructions to assign, by the one or more computer processors, a predefined starting value to a primary index variable;
program instructions to repeat:
determining, by the one or more computer processors, a cumulative probability value, the cumulative probability value being associated with the primary index variable; and
incrementing, by the one or more computer processors, the value of the primary index variable;
until the cumulative probability value is greater than or equal to the qualified uniform random number; and
responsive to the cumulative probability value being greater than or equal to the qualified uniform random number, program instructions to assign, by the one or more computer processors, the value of the primary index variable to an output random number.

16. The computer system of claim 15, further comprising program instructions to:
determine, by the one or more computer processors, a sign indicator, the sign indicator being associated with the qualified uniform random number; and
adjust, by the one or more computer processors, the output random number based on the sign indicator.

17. The computer system of claim 15, wherein at least one of the approximation recurrence relationship or each cumulative probability value is determined, by the one or more computer processors, based on one or more properties associated with at least one normal information transmission channel.

18. The computer system of claim 15, wherein program instructions to determine the approximation recurrence relationship further comprise instructions to:
determine, by the one or more computer processors, a qualified constant number; and
determine, by the one or more computer processors, a poisson approximation recurrence relationship based on the qualified constant number.

19. The computer system of claim 15, wherein program instructions to determine the cumulative probability value further comprise program instructions to:
identify, by the one or more computer processors, a global probability sum, the global probability sum being associated with the primary index variable; and
for each secondary index variable in the range from the predefined starting value to the primary index value:
determine, by the one or more computer processors, an individual probability value based on the approximation recurrence relationship, the individual probability value being associated with the secondary index value; and
adjust, by the one or more computer processors, the global probability sum based on the individual probability value.

20. The computer system of claim 19, wherein adjusting the global probability sum is performed, by the one or more computer processors, according to a trapezoidal summation relationship between the individual probability values corresponding to each secondary value.
